(19) United States
(12) Patent Application Publication
(10) Pub. No.: US 2026/0252272 A1
(43) Pub. Date: Aug. 27, 2026

(54) NON-VOLATILE MEMORY USING SEPARATE COMMAND ADDRESS PROTOCOL, STORAGE DEVICE INCLUDING THE SAME AND METHOD THEREOF

(71) Applicant: SAMSUNG ELECTRONICS CO., LTD., Suwon-si (KR)

(72) Inventors: Hyunjoon YOO, Suwon-si (KR); Yong-Taek JEONG, Suwon-si (KR)

(73) Assignee: SAMSUNG ELECTRONICS CO., LTD., Suwon-si (KR)

(21) Appl. No.: 19/408,926

(22) Filed: Dec. 4, 2025

(30) Foreign Application Priority Data
Dec. 5, 2024 (KR) 10-2024-0179455

(51) Int. Cl. G06F 3/06

(52) U.S. Cl. CPC G06F 3/0659; G06F 3/0613; G06F 3/0679

(57) ABSTRACT

A storage device includes a plurality of non-volatile memories, and a storage controller connected to the plurality of non-volatile memories through a data line and a command address line separated from the data line. The plurality of non-volatile memories are respectively configured to transmit peak current information through the command address line after on die termination (ODT) for all of the plurality of non-volatile memories is disabled.

### CROSS-REFERENCE TO RELATED APPLICATIONS

This application claims priority under 35 U.S.C. § 119 to Korean Patent Application No. 10-2024-0179455 filed on Dec. 5, 2024, in the Korean Intellectual Property Office, the disclosures of which are incorporated by reference herein in their entireties.

### BACKGROUND

Embodiments of the present disclosure described herein relate to a non-volatile memory using a separate command address protocol, a storage device including the same, and a method thereof.

A semiconductor memory device may be mainly classified as a volatile memory or a non-volatile memory. Read and write speeds of the volatile memory (e.g., a DRAM or an SRAM) are fast, but data stored in the volatile memory disappear when a power is turned off. In contrast, the non-volatile memory may retain data stored therein even when a power is turned off. A representative example of the non-volatile memory is a flash memory.

Meanwhile, with the development of technologies, improvement of a data input/output speed of the non-volatile memory is being required. In particular, it is difficult to satisfy the demand on the high speed by using an interface manner in which a command, an address, and data are input by using an existing input/output (I/O) pin. A separate command address protocol in which a command address line (or pin) and a data line (or pin) are separated is used to implement the high speed.

### SUMMARY

Embodiments of the present disclosure provide a non-volatile memory sharing peak current information by using a separate command address protocol, a storage device including the same, and a method thereof.

According to an embodiment, a storage device includes a plurality of non-volatile memories, and a storage controller connected to the plurality of non-volatile memories through a data line and a command address line separated from the data line. The plurality of non-volatile memories are respectively configured to transmit peak current information through the command address line after on die termination (ODT) for all of the plurality of non-volatile memories is disabled.

According to an embodiment, a method of operating a non-volatile memory includes disabling on die termination (ODT) for all of a plurality of non-volatile memories included in the non-volatile memory, based on an ODT command indicating a disable of the ODT, and transmitting peak current information through a command address line separated from a data line.

According to an embodiment, a non-volatile memory includes a memory cell array, an input/output circuit connected to a data line transmitting write data or read data associated with the memory cell array and a command address line separated from the data line and enabling or disabling on die termination (ODT), and a control logic circuit. The control logic circuit is configured to disable the ODT based on controlling the input/output circuit and then transmit peak current information through the command address line.

### BRIEF DESCRIPTION OF THE FIGURES

The above and other objects and features of the present disclosure will become apparent by describing in detail embodiments thereof with reference to the accompanying drawings.

FIG. 1 is a block diagram of a storage device according to some example embodiments.

FIG. 2 is a block diagram of a storage controller of FIG. 1, according to some example embodiments.

FIG. 3 is an example block diagram of a non-volatile memory of FIG. 1, according to some example embodiments.

FIG. 4 is a circuit diagram illustrating an example of a memory block in a memory cell array of FIG. 3, according to some example embodiments.

FIG. 5 is a block diagram of a storage device according to some example embodiments.

FIG. 6 is a timing diagram of a peak current information sharing operation of a storage device according to some example embodiments.

FIG. 7 is a timing diagram of a peak current information sharing operation after a storage device according to some example embodiments enters a command address output mode.

FIG. 8 is a detailed timing diagram of a peak current information sharing operation after a storage device according to some example embodiments enters a command address output mode.

FIG. 9 illustrates a plurality of non-volatile memories according to some example embodiments.

FIGS. 10A and 10B are detailed timing diagrams of a peak current information sharing operation based on an internal clock signal after a storage device according to some example embodiments enters a command address output mode.

FIG. 11 is a detailed timing diagram of a peak current information sharing operation when a storage device according to some example embodiments enters a command address output mode and ends the command address output mode.

FIG. 12 is a timing diagram of a peak current information sharing operation and a program operation of a storage device according to some example embodiments.

FIG. 13 is a flowchart of an operating method of a non-volatile memory according to some example embodiments.

FIG. 14 is a flowchart of a command address output mode entering method according to some example embodiments.

FIG. 15 is a flowchart of an operating method of a storage device according to some example embodiments.

### DETAILED DESCRIPTION

Below, embodiments of the present disclosure will be described in detail and clearly to such an extent that one skilled in the art easily carries out the present disclosure.

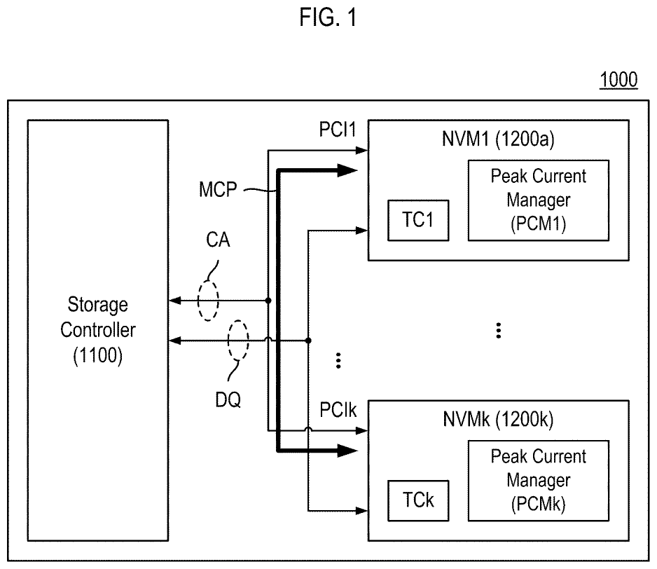

FIG. 1 is a block diagram of a storage device according to some example embodiments.

Referring to FIG. 1, a storage device 1000 according to some example embodiments may include a storage controller 1100 and a plurality of non-volatile memories 1200a to 1200k.

The storage controller 1100 may be configured to control the plurality of non-volatile memories 1200a to 1200k under control of a host or depending on a command of the host. For example, depending on the request of the host, the storage controller 1100 may write data in the plurality of non-volatile memories 1200a to 1200k or may read data stored in the plurality of non-volatile memories 1200a to 1200k.

In some example embodiments, a separate command address (SCA) protocol may be applied to the storage controller 1100 and the plurality of non-volatile memories 1200a to 1200k. In detail, as the SCA protocol is applied, the storage controller 1100 and the plurality of non-volatile memories 1200a to 1200k may be connected to each other through a data line DQ and a command address line CA separated from the data line DQ. In this case, the storage controller 1100 and the plurality of non-volatile memories 1200a to 1200k may exchange write data or read data through the data line DQ. Also, the storage controller 1100 may transmit a command and an address for control to the plurality of non-volatile memories 1200a to 1200k through the command address line CA.

In some example embodiments, the plurality of non-volatile memories 1200a to 1200k may transmit information to be mutually shared through the command address line CA. Also, the information shared through the command address line CA may not be shared with the storage controller 1100. In the present disclosure, an operation in which the plurality of non-volatile memories 1200a to 1200k mutually transmit or share information through the command address line CA may be referred to as “inter-memory communication”. In the inter-memory communication, the command address line CA is used as an inter-memory communication path MCP to transmit or receive information to be shared between the plurality of non-volatile memories 1200a to 1200k. In this case, the storage controller 1100 may transmit a command and an address through the command address line CA.

According to some example embodiments, the storage controller 1100 and the plurality of non-volatile memories 1200a to 1200k may perform an operation(s) for initiating the inter-memory communication (or for entering a mode for performing the inter-memory communication).

Under control of the storage controller 1100, the plurality of non-volatile memories 1200a to 1200k may store data or may transfer the stored data to the storage controller 1100. For example, the plurality of non-volatile memories 1200a to 1200k may be implemented with a NAND flash memory device, but embodiments of the present disclosure are limited thereto. The plurality of non-volatile memories 1200a to 1200k may include k non-volatile memories (k being a natural number), and each of the non-volatile memories 1200a to 1200k may be implemented with a chip or a die.

As some example embodiments, each of the plurality of non-volatile memories 1200a to 1200k may include an on-die termination circuit and a peak current manager. That is, the plurality of non-volatile memories 1200a to 1200k may include a plurality of on-die termination circuits TC1 to TCk and a plurality of peak current managers PCM1 to PCMk.

The plurality of on-die termination circuits TC1 to TCk may be configured to support the termination for the plurality of non-volatile memories 1200a to 1200k. Through the plurality of on-die termination circuits TC1 to TCk, the on die termination (ODT) may be enabled (or on or turned on) or disabled (or off or turned off) for each non-volatile memory. In the present disclosure, that the ODT of one non-volatile memory is enabled may be defined as the corresponding non-volatile memory is terminated. Each of the on-die termination circuits TC1 to TCk respectively included in the non-volatile memories 1200a to 1200k may terminate the corresponding non-volatile memory.

In contrast, that the ODT of one non-volatile memory is disabled may be defined as the corresponding non-volatile memory is un-terminated. Each of the on-die termination circuits TC1 to TCk respectively included in the non-volatile memories 1200a to 1200k may not terminate the corresponding non-volatile memory.

The ODT may be individually enabled or disabled in each of the plurality of non-volatile memories 1200a to 1200k. That is, the plurality of on-die termination circuits TC1 to TCk are capable of supporting the ODT individually. For example, the ODT of a non-volatile memory which is a target receiving a specific signal or is targeted for a specific operation may be disabled. In this case, the ODT of the remaining non-volatile memories may be enabled, and thus, the reflection of signal may be suppressed.

As some example embodiments, all of the plurality of on-die termination circuits TC1 to TCk may be disabled. As the plurality of on-die termination circuits TC1 to TCk are disabled, the ODT of all of the plurality of non-volatile memories 1200a to 1200k may be disabled. When the ODT of all of the plurality of non-volatile memories 1200a to 1200k is disabled, the plurality of non-volatile memories 1200a to 1200k may be in a state where it is possible to receive data transmitted or shared through the command address line CA. Accordingly, the disable of the ODT of the plurality of non-volatile memories 1200a to 1200k may be defined as a condition for initiating the inter-memory communication. The plurality of non-volatile memories 1200a to 1200k may initiate the inter-memory communication through the disable of the plurality of on-die termination circuits TC1 to TCk.

The plurality of peak current managers PCM1 to PCMk may be configured to calculate (or predict) a peak current value from the amount of current which the plurality of non-volatile memories 1200a to 1200k use. The plurality of peak current managers PCM1 to PCMk may generate (or obtain) peak current information PCI1 to PCIk by calculating values of peak currents which the plurality of non-volatile memories 1200a to 1200k use and coding (or quantizing) the calculated peak current values. For example, the peak current value may be defined as a current value corresponding to a current amount at a calculation (or prediction) time point or to a peak within a specific time interval.

The plurality of peak current managers PCM1 to PCMk may control operations scheduled for the plurality of non-volatile memories 1200a to 1200k based on the peak current information PCI1 to PCIk.

As some example embodiments, each peak current manager may manage peak current values which peak current information received from the remaining non-volatile memories through the command address line CA indicate.

As some example embodiments, when a peak current value is greater than or equal to a threshold value, each peak current manager may stop the operation scheduled for each non-volatile memory.

As some example embodiments, each peak current manager may sum the peak current values received from the remaining non-volatile memories and may stop the operation scheduled for each non-volatile memory when a summed value according to the sum is greater than or equal to the threshold value.

After the ODT of all of the plurality of non-volatile memories 1200a to 1200k is disabled, the plurality of non-volatile memories 1200a to 1200k may transmit the peak current information PCI1 to PCIk generated through the plurality of peak current managers PCM1 to PCMk through the command address line CA. That is, the plurality of non-volatile memories 1200a to 1200k may mutually share the peak current information PCI1 to PCIk based on the inter-memory communication.

The storage device 1000 according to the above embodiments makes it possible for the plurality of non-volatile memories 1200a to 1200k to share the peak current information PCI1 to PCIk by utilizing the command address line CA separated from the data line DQ, which is applied through the SCA protocol. Accordingly, an additional channel for sharing the peak current information PCI1 to PCIk between the plurality of non-volatile memories 1200a to 1200k may not be required. This may mean that the number of channels decreases. In other words, the printed circuit board area for implementing the storage device 1000 may be reduced.

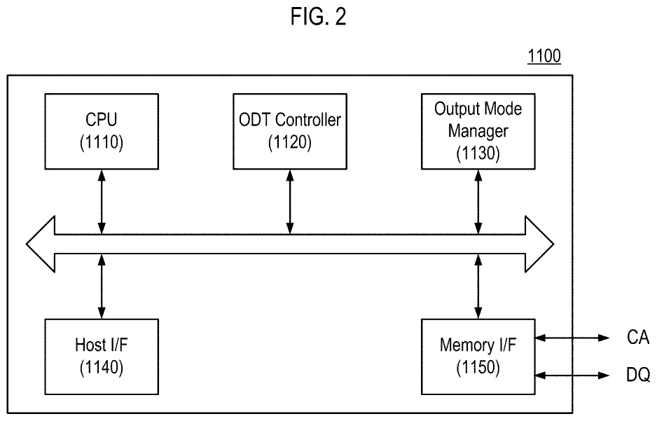

FIG. 2 is a block diagram of a storage controller of FIG. 1, according to some example embodiments.

Referring to FIG. 2, the storage controller 1100 according to some example embodiments may include a central processing unit (CPU) 1110, an ODT controller 1120, an output mode manager 1130, a host interface 1140 and a memory interface 1150. The components of the storage controller 1100 may be connected to each other through a system bus.

The CPU 1110 may include a processing unit such as a micro-processor. The CPU 1110 may control all operations of the storage controller 1100. The CPU 1110 may execute firmware for driving the storage controller 1100. For example, the CPU 1110 may execute various firmware loaded to a code memory (not illustrated).

As some example embodiments, when the ODT controller 1120 and/or the output mode manager 1130 is provided as a software module, the CPU 1110 may execute the software module corresponding to the ODT controller 1120 and/or the output mode manager 1130 and may perform operations of the storage controller 1100 of the present disclosure, as well as ODT enable and disable and entry management to an output mode.

As some example embodiments, the CPU 1110 may include a plurality of cores. Each of the plurality of cores may be implemented with an independent processor core. The plurality of cores may include a host core, a flash translation layer (FTL) core, and a NAND core.

The host core may be defined as an internal core of a storage device (e.g., 1000 of FIG. 1), which performs an operation associated with a host interface layer (HIL). For example, the host core may process a request received from the host through the host interface 1140.

The FTL core may be defined as an internal core of the storage device, which performs an operation associated with the FTL. For example, the FTL core may control the NAND core based on the request received from the host core such that the read operation, the write operation, or the erase operation is performed in non-volatile memories (e.g., 1200a to 1200k of FIG. 1). Alternatively, by using the FTL, the FTL core may perform an address mapping operation such that a logical block address (LBA) transmitted from the host is mapped to a physical block address (PBA) indicating a physical location of a non-volatile memory.

The NAND core may be defined as an internal core of the storage device, which performs an operation associated with a flash interface layer (FIL). For example, under control of the FTL core, the NAND core may control the memory interface 1150 such that operations of the non-volatile memory are performed.

The ODT controller 1120 may be configured to control the enable and disable of the ODT of a non-volatile memory connected to the storage controller 1100.

As some example embodiments, the ODT controller 1120 may generate an ODT command indicating whether to enable the ODT and may transmit the generated ODT command through the command address line CA or the data line DQ. For example, a first ODT command may indicate the disable of the non-volatile memory, and a second ODT command may indicate the enable of the non-volatile memory.

As some example embodiments, when the above SCA protocol is applied to the storage controller 1100, the ODT controller 1120 may transmit the ODT command through the command address line CA. For example, the command address line CA through which the ODT command is transmitted/received may be CA[1:0] being a 2-bit signal line.

For example, the ODT command may be provided in the form of a packet. The ODT packet may include an enable bit indicating the enable or disable of the non-volatile memory. When the enable bit has a first logical value (e.g., logic “high”), the ODT of the non-volatile memory may be enabled; when the enable bit has a second logical value (e.g., logic “low”), the ODT of the non-volatile memory may be disabled. For example, the ODT packet may include a selection bit indicating whether to select, as an ODT target, all non-volatile memories corresponding to a logical unit number (LUN) and selected depending on a chip enable signal or whether to select a non-volatile memory corresponding to a specific LUN as an ODT target. When the selection bit has a specific value, the ODT may be enabled or disabled in association with all the selected LUNs.

The non-volatile memory may receive the ODT packet through the command address line CA and may enable or disable the ODT based on the received ODT packet.

Under control of the output mode manager 1130 the non-volatile memory connected to the storage controller 1100 may enter the output mode. Below, in the present disclosure, the output mode (or the command address output mode) means a mode in which the non-volatile memory is a subject transmitting data or a signal through the command address line CA. That is, the non-volatile memory entering the output mode may transmit data, a signal (or a packet), etc. to the storage controller 1100.

As some example embodiments, the output mode manager 1130 may generate a command address output signal for entering the output mode and may transmit the generated command address output signal through the command address line CA. For example, the command address output signal may be defined as a header constituting a command address output packet. The output mode manager 1130 may set the command address line CA to a high-impedance (Hi-Z) state during a given time after the command address output signal is transmitted.

The non-volatile memory may receive the command address output signal through the command address line CA and may enter the command address output mode based on the received command address output signal. The non-volatile memory may transmit preamble data to the storage controller 1100 after entering the command address output mode and may then transmit a body signal constituting the command address output packet. According to some example embodiments, the non-volatile memory may output single-byte output data or multiple-byte output data in the command address output mode.

As some example embodiments, the output mode manager 1130 may transmit the command address output signal after the ODT of all non-volatile memories is disabled through the ODT controller 1120. In this case, after the ODT is disabled, the non-volatile memory may enter the command address output mode based on the command address output signal.

The non-volatile memory entering the command address output mode through the output mode manager 1130 may be a subject transmitting data or a signal on the own command address line CA. According to some example embodiments, the entry to the command address output mode may be defined as an initiation condition of the inter-memory communication for transmitting a signal on the command address line CA. In this case, after the ODT of all of the plurality of non-volatile memories is disabled and all of the plurality of non-volatile memories enter the command address output mode, all of the plurality of non-volatile memories may initiate the inter-memory communication.

Alternatively, as described above, the plurality of non-volatile memories may initiate the inter-memory communication through the disable of the ODT without entering the command address output mode.

The host interface 1140 provides an interface between the host and the storage controller 1100. The host and the storage controller 1100 may be connected through one of various standardized interfaces. Herein, the standardized interfaces include various interfaces such as an advanced technology attachment (ATA) interface, a serial ATA (SATA) interface, an external SATA (e-SATA) interface, a small computer small interface (SCSI), a serial attached SCSI (SAS), a peripheral component interconnection (PCI) interface, a PCI Express (PCI-E) interface, a universal serial bus (USB) interface, an IEEE 1394 interface, a universal flash store (UFS) interface, and a card interface.

The memory interface 1150 provides interfacing between the storage controller 1100 and the non-volatile memory. For example, data processed by the CPU 1110 may be stored in the non-volatile memory through the memory interface 1150, or data read from the non-volatile memory may be transferred to the storage controller 1100 through the memory interface 1150.

The memory interface 1150 according to some example embodiments may be configured to communicate with the non-volatile memory based on the SCA protocol. That is, the memory interface 1150 may communicate with the non-volatile memory through the command address line CA implemented independently of the data line DQ. For example, through the command address line CA, the memory interface 1150 may transmit the ODT packet generated from the ODT controller 1120 and the command address output signal generated from the output mode manager 1130.

In addition, the memory interface 1150 may transfer a command packet and/or an address packet to the non-volatile memory through the command address line CA.

The storage controller 1100 according to the above embodiments may control the disable of the ODT and the entry to the command address output mode such that the plurality of non-volatile memories perform the inter-memory communication.

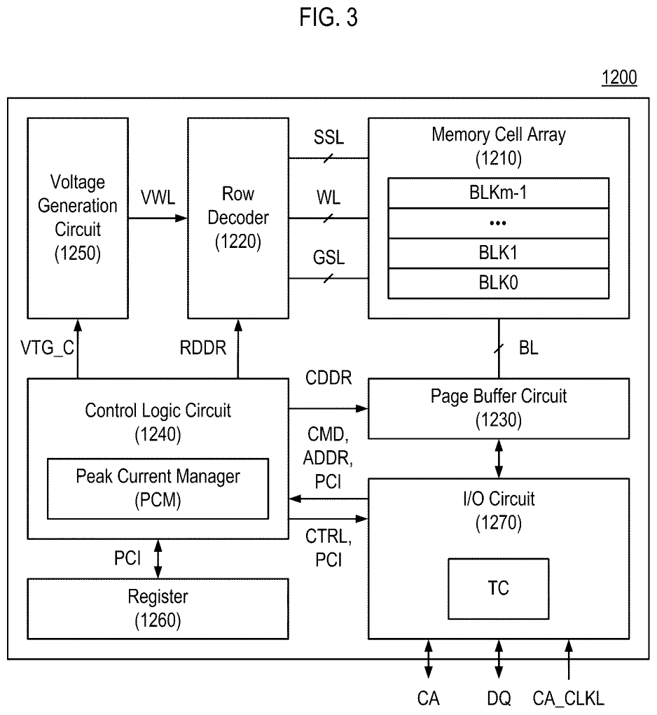

FIG. 3 is an example block diagram of a non-volatile memory of FIG. 1, according to some example embodiments.

Referring to FIG. 3, a non-volatile memory 1200 according to some example embodiments may include a memory cell array 1210, a row decoder 1220, a page buffer circuit 1230, a control logic circuit 1240, a voltage generation circuit 1250, a register 1260, and an input/output circuit 1270. Also, although not illustrated in FIG. 3, the non-volatile memory 1200 may further include components such as column logic, a pre-decoder, a temperature sensor, a command decoder, and an address decoder. Also, the non-volatile memory 1200 may be one of the plurality of non-volatile memories 12001 to 1200k illustrated in FIG. 1.

The memory cell array 1210 may include a plurality of memory blocks BLK0 to BLKm-1 (m being a positive integer). Each of the plurality of memory blocks BLK0 to BLKm-1 may include a plurality of memory cells. Each of the plurality of memory blocks BLK0 to BLKm-1 may be composed of a plurality of pages. Each page may be composed of a plurality of memory cells. Each memory block may correspond to an erase unit, and each page may correspond to a read or program unit. The plurality of memory blocks BLK0 to BLKm-1 may be included in one memory plane, but embodiments of the present disclosure are not limited thereto. The memory cell array 1210 may be connected to the page buffer circuit 1230 through bit lines BL and may be connected to the row decoder 1220 through word lines WL, string selection lines SSL, and ground selection lines GSL.

As some example embodiments, the memory cell array 1210 may include a 3D memory cell array. The 3D memory cell array may be implemented with a plurality of levels and may include word lines or bit lines which are shared between levels.

The row decoder 1220 may select one of the memory blocks BLK0 to BLKm-1 of the memory cell array 1210 in response to a row address RDDR. The row decoder 1220 may select one of word lines of the selected memory block in response to the row address RDDR. The row decoder 1220 transfers a voltage VWL corresponding to an operation mode to the selected word line of the selected memory block. In the program operation, the row decoder 1220 transfers a program voltage and a verify voltage to the selected word line and a pass voltage to the unselected word lines. In the read operation, the row decoder 1220 transfers a read voltage to the selected word line and a read pass voltage to the unselected word lines.

The page buffer circuit 1230 may include a plurality of page buffers. The plurality of page buffers may be respectively connected to memory cells through the bit lines BL. The page buffer circuit 1230 may select at least one of the bit lines BL in response to a column address CDDR provided from the control logic circuit 1240. The page buffer circuit 1230 may operate as a write driver or a sense amplifier depending on an operation mode. For example, in the program operation, the page buffer circuit 1230 may apply a bit line voltage corresponding to data to be programmed to a selected bit line. In the read operation, the page buffer circuit 1230 may read data stored in a memory cell by sensing a current or a voltage of the selected bit line.

The control logic circuit 1240 may overall control various kinds of operations of the non-volatile memory 1200. The control logic circuit 1240 may generate various kinds of control signals for programming data in the memory cell array 1210, reading data from the memory cell array 1210, or erasing data stored in the memory cell array 1210 in response to a control signal CTRL, a command CMD, and/or an address ADDR. For example, the control logic circuit 1240 may output a voltage control signal VTG_C, the row address RDDR, and the column address CDDR, etc.

The control logic circuit 1240 may include a peak current manager PCM. The peak current manager PCM may perform the above operations described with reference to FIG. 1. As some example embodiments, the peak current manager PCM may calculate (or predict) a peak current value and may generate peak current information PCI including the peak current value.

As some example embodiments, the peak current manager PCM may store the generated peak current information PCI in the register 1260. Alternatively, the peak current manager PCM may program the peak current information PCI in the memory cell array 1210.

As some example embodiments, the peak current manager PCM may control an operation scheduled for the non-volatile memory 1200, based on the peak current information PCI received from the remaining non-volatile memories 1200. For example, when the scheduled operation is the program operation and the peak current value indicated by the peak current information PCI is greater than or equal to the threshold value, the peak current manager PCM may stop generating or providing the voltage control signal VTG_C corresponding to the program voltage or may stop generating or providing the row address RDDR and/or the column address CDDR.

As some example embodiments, the control logic circuit 1240 may generate the control signal CTRL for controlling an on-die termination circuit TC included in the input/output circuit 1270 and may transmit the generated control signal CTRL to the input/output circuit 1270. The control signal CTRL may be defined to indicate the enable or disable of the on-die termination circuit TC. Accordingly, the control logic circuit 1240 may control the input/output circuit 1270 to enable or disable the ODT.

As some example embodiments, after the control logic circuit 1240 controls the input/output circuit 1270 such that the ODT is disabled, the control logic circuit 1240 may transmit the generated or obtained peak current information PCI through the command address line CA.

The voltage generation circuit 1250 may generate various kinds of voltages for performing the program, read, and erase operations based on the voltage control signal VTG_C. For example, the voltage generation circuit 1250 may generate the program voltage, the read voltage, the program verify voltage, etc. as the word line voltage VWL. For example, the program voltage may be generated in an incremental step pulse program (ISPP) manner.

The register 1260 may store the peak current information PCI generated or obtained according to the above embodiments. In this case, the peak current information PCI may be associated with the non-volatile memory 1200 or may be associated with the remaining non-volatile memories 1200. Alternatively, when the peak current value is coded, the register 1260 may store a peak current value mapped to a coded bit. For example, the register 1260 may store a mapping table defining a mapping relationship between the coded bit and the peak current value.

The input/output circuit 1270 may be configured to receive the command CMD, the address ADDR, data, etc. provided from a storage controller. The command CMD and the address ADDR received through the input/output circuit 1270 may be provided to the control logic circuit 1240.

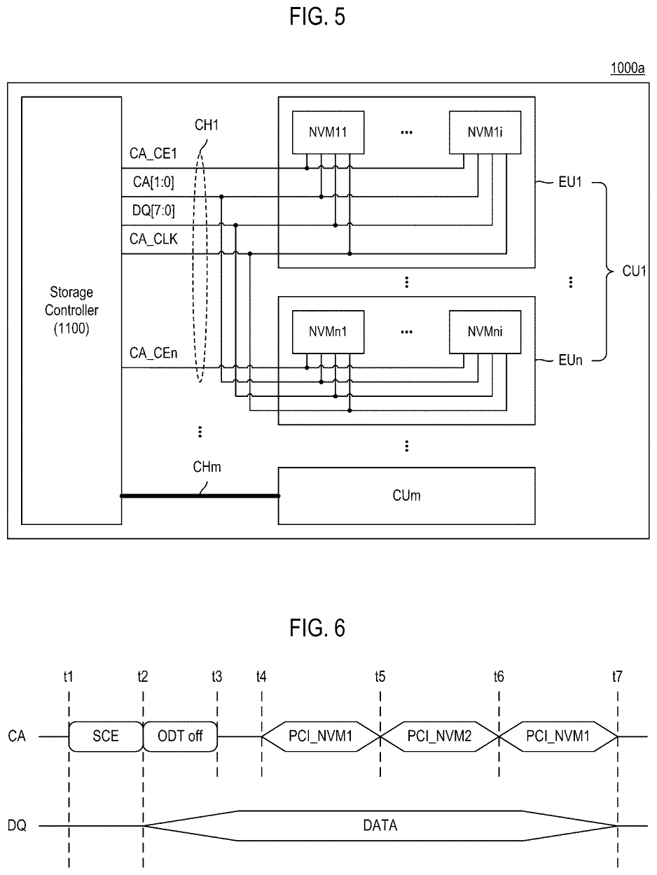

As some example embodiments, the input/output circuit 1270 may be connected to the command address line CA and may receive the command CMD and the address ADDR through the command address line CA. Also, through the data line DQ, the input/output circuit 1270 may transmit the write data to be written in the memory cell array 1210 or the read data read from the memory cell array 1210. For example, the input/output circuit 1270 may transfer program data received through the data line DQ to the page buffer circuit 1230 or may transmit data read through the page buffer circuit 1230 to the outside (e.g., a storage controller). The input/output circuit 1270 may receive the command CMD and the address ADDR transferred through the command address line CA in synchronization with a command address clock signal CA_CLK (refer to FIG. 5) provided from a command address clock line CA_CLKL. The storage controller (e.g., refer to FIGS. 1 and 2) according to the above embodiments may generate the command address clock signal CA_CLK for the command address line CA and may transmit the command address clock signal CA_CLK to the non-volatile memory 1200 through the command address clock line CA_CLKL.

As some example embodiments, based on that the ODT of the plurality of non-volatile memories 1200 is disabled and/or that the plurality of non-volatile memories enter the command address output mode, the input/output circuit 1270 may transmit the peak current information PCI to the remaining non-volatile memories through the command address line CA or may receive the peak current information PCI from the remaining non-volatile memories.

As some example embodiments, the input/output circuit 1270 may include the on-die termination circuit TC. The input/output circuit 1270 may enable or disable the ODT through the on-die termination circuit TC. The on-die termination circuit TC may be enabled or disabled based on the control signal CTRL provided from the control logic circuit 1240. When the on-die termination circuit TC is enabled, a termination resistor for a pin (or a pad) connected to the command address line CA, the data line DQ, and/or the command address clock line CA_CLKL may be provided. That is, the non-volatile memory 1200 may be terminated.

Alternatively, when the on-die termination circuit TC is disabled, the termination resistor for the pin (or the pad) connected to the command address line CA, the data line DQ, and/or the command address clock line CA_CLKL may not be provided. That is, the non-volatile memory 1200 may not be terminated.

According to some example embodiments, when the inter-memory communication is initiated, the input/output circuit 1270 may transmit the peak current information PCI received through the control logic circuit 1240 to the remaining non-volatile memories through the command address line CA. Alternatively, the input/output circuit 1270 may receive the peak current information PCI provided from the remaining non-volatile memories through the command address line CA.

The non-volatile memory 1200 according to the above embodiments makes it possible to share the peak current information PCI with the remaining non-volatile memories through the command address line CA.

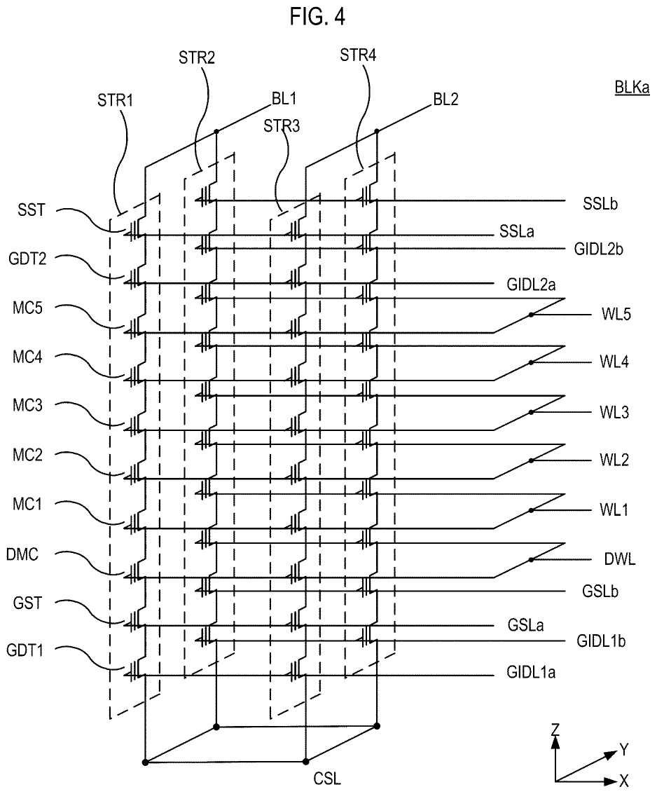

FIG. 4 is a circuit diagram illustrating an example of a memory block in a memory cell array of FIG. 3, according to some example embodiments. For convenience of description, it is assumed that four strings STR1 to STR4 are included in one memory block.

Referring to FIG. 4, a memory block BLKa may include the plurality of strings STR1 to STR4 vertically stacked on a substrate. The plurality of strings STR1 to STR4 may be arranged in a first direction (i.e., an X-axis direction) and a second direction (i.e., a Y-axis direction).

Strings located at the same column from among the plurality of strings STR1 to STR4 may be connected to the same bit line. For example, the first and second strings STR1 and STR2 may be connected to a first bit line BL1, and the third and fourth strings STR3 and STR4 may be connected to a second bit line BL2.

Each of the plurality of strings STR1 to STR4 may include a plurality of cell transistors. Each of the plurality of cell transistors may include a charge trap flash (CTF) memory cell, but embodiments of the present disclosure are not limited thereto. The plurality of cell transistors may be stacked in a third direction (i.e., a Z-axis direction).

The plurality of strings STR1 to STR4 may be connected in common to a common source line CSL. For example, as illustrated in FIG. 4, the common source line CSL may be connected in common to lower ends of the plurality of strings STR1 to STR4. However, this is provided as an example. It is sufficient if the common source line CSL is electrically connected to the lower ends of the strings STR1 to STR4, and the present disclosure is not limited to the case that the common source line CSL is physically located at the lower ends of the strings STR1 to STR4. Below, for convenience of description, a structure and a configuration of a string will be described based on the first string STR1. The remaining strings STR2, STR3, and STR4 may be similar in structure to the first string STR1, and thus, additional description will be omitted to avoid redundancy.

The plurality of cell transistors may be connected in series between the first bit line BL1 and the common source line CSL. For example, the plurality of cell transistors may include GIDL transistors GDT1 and GDT2, a string selection transistor SST, memory cells MC1 to MC5, a dummy memory cell DMC, and a ground selection transistor GST.

The first GIDL transistor GDT1 may be disposed at the lowermost end of the first string STR1. For example, the first GIDL transistor GDT1 may be connected to the common source line CSL at the lower end of the string STR1. However, this is provided as an example, and embodiments of the present disclosure are not limited thereto. A gate of the first GIDL transistor GDT1 may be connected to a first GIDL line GIDL1a.

The second GIDL transistor GDT2 may be disposed at an upper end of the string STR1, in detail, may be disposed between the string selection transistor SST and the memory cell MC5. That is, the second GIDL transistor GDT2 may be connected to the first bit line BL1 through the string selection transistor SST. A gate of the second GIDL transistor GDT2 may be connected to a second GIDL line GIDL2a.

The GIDL transistors GDT1 and GDT2 are illustrated in FIG. 4 as being provided at the upper end and the lower end of the string STR1. However, this is provided as an example. According to an embodiment, the GIDL transistor may be provided only at the upper end of the string STR1, or the GIDL transistor may be provided only at the lower end of the string STR1.

One string selection transistor SST may be disposed at the uppermost end of the string STR. The string selection transistor SST may be connected to the first bit line BL1 at the upper end of the string STR1. A gate of the string selection transistor SST may be connected to a string selection line SSLa. However, this is provided as an example. According to an embodiment, a plurality of string selection transistors which are connected in series may be provided between the first bit line BL1 and the second GIDL Transistor GDT2.

One ground selection transistor GST may be provided between the dummy memory cell DMC and the first GIDL transistor GDT1. A gate of the ground selection transistor GST may be connected to a ground selection line GSLa. However, this is provided as an example. According to an embodiment, a plurality of ground selection transistors which are connected in series may be provided between the dummy memory cell DMC and the first GIDL transistor GDT1.

The first to fifth memory cells MC1 to MC5 may be connected in series between the string selection transistor SST and the dummy memory cell DMC. Gates of the first to fifth memory cells MC1 to MC5 may be respectively connected to first to fifth word lines WL1 to WL5.

One dummy memory cell DMC may be provided between the first memory cell MC1 and the first GIDL transistor GDT1. A gate of the dummy memory cell DMC may be connected to a dummy word line DWL. However, this is provided as an example. According to an embodiment, a plurality of dummy memory cells which are connected in series may be provided between the first memory cell MC1 and the first GIDL transistor GDT1. Alternatively, an additional dummy memory cell may be provided between the string selection transistor SST and the fifth memory cell MC5. Alternatively, an additional dummy memory cell may be provided between the memory cells MC1 to MC5. Alternatively, the dummy memory cell DMC may not be provided.

FIG. 5 is a block diagram of a storage device according to some example embodiments. Below, the description associated with components the same as the above components will be omitted to avoid redundancy.

Referring to FIG. 5, a storage device 1000a according to some example embodiments may include the storage controller 1100 and a plurality of channel units CU1 to CUm. The plurality of channel units CU1 to CUm may be connected to the storage controller 1100 through a plurality of channels CH1 to CHm. For example, the plurality of channel units CU1 to CUm may be implemented with one or more memory packages, but embodiments of the present disclosure are not limited thereto. Also, an example in which a command address chip enable signal is provided in plurality is illustrated in FIG. 5, but it may be understood that one command address chip enable signal is provided for each channel.

For example, the plurality of channels CH1 to CHm may include m channels (m being a natural number of 2 or more). Each of the plurality of channel units CU1 to CUm may include a plurality of non-volatile memories. In this case, each non-volatile memory may be implemented according to the above embodiments (e.g., refer to FIGS. 1 and 3).

Each of the plurality of channel units CU1 to CUm may include a plurality of enable units EU1 to EUn. For example, the plurality of enable units EU1 to EUn may include n enable units (n being a natural number of 2 or more). Each of the plurality of enable units EU1 to EUn may include i non-volatile memories (i being a natural number of 2 or more). For example, the first enable unit EU1 include a plurality of non-volatile memories NVM11 to NVM1i.

One channel unit may be connected to the storage controller 1100 through one channel, and one enable unit may be connected to the storage controller 1100 through one command address enable line. The number of channels CH1 to CHm, denoted as “m”, the number of enable units EU1 to EUn, denoted as “n”, and the number of non-volatile memories included each enable unit, denoted as “i”, may be variously set or defined.

The storage controller 1100 may provide a channel unit with one command address signal CA[1:0], one data signal DQ[7:0], and one command address clock signal CA_CLK through one channel. Also, the storage controller 1100 may provide a channel unit with a plurality of command address chip enable signals CA_CE1 to CA_CEn through one channel. The plurality of command address chip enable signals CA_CE1 to CA_CEn may respectively correspond to enable units included in a channel unit and thus may include n command address chip enable signals.

The command address chip enable signal may enable a command address line for LUNs (i.e., i enable units) connected to the command address chip enable signal. For example, the first command address chip enable signal CA_CE1 may enable or select the first enable unit EU1 included in the first channel unit CU1, and the n-th command address chip enable signal CA_CEn may enable or select the n-th enable unit EUn included in the first channel unit CU1.

The command address signal CA[1:0], the data signal DQ[7:0], and the command address clock signal CA_CLK transmitted through one channel may be provided in common to one channel unit. For example, the command address signal CA[1:0], the data signal DQ[7:0], and the command address clock signal CA_CLK transmitted through the first channel CH1 may be provided in common to the first channel unit CU1. The command address signal CA[1:0], the data signal DQ[7:0], and the command address clock signal CA_CLK may be provided to one or more enable units enabled or selected by the command address chip enable signal.

The command address line may transmit the first command address signal and the second command address signal CA[1:0] which are synchronized to the rising edge and the falling edge of the command address clock signal CA_CLK for the command address line. The command address signal CA[1:0] may be a 2-bit signal. The command address signal CA[1:0] may control a type of a command address packet. For example, the 2-bit signal may include the first command address signal and the second command address signal CA[1:0]. When the first command address signal CA[1] and the second command address signal CA[0] transmit the header, the first command address signal CA[1] and the second command address signal CA[0] may transmit the header in synchronization with the rising edge and the falling edge of the command address clock signal CA_CLK, and the type and the mode of the command address packet may be defined depending on a value of the header. For example, it may be possible to enter the above command address output mode depending on the value of the header.

The command address signal CA[1:0] may be provided from the storage controller 1100 to the plurality of channel units CU1 to CUm through the plurality of channels CH1 to CHm. Alternatively, in the command address output mode, the command address signal CA[1:0] may be provided from the plurality of channel units CU1 to CUm to the storage controller 1100 through the plurality of channels CH1 to CHm. According to various examples, the command address signal CA[1:0] may include packets for controlling a non-volatile memory.

As some example embodiments, during the inter-memory communication, the command address signal CA[1:0] may include the peak current information. In this case, the command address signal CA[1:0] may be shared between at least some of non-volatile memories included in the plurality of enable units EU1 to EUn.

The data signal DQ[7:0] may be an 8-bit signal. A data line through which the data signal DQ[7:0] is transmitted and an operation according to the data signal DQ[7:0] may be controlled through the command address signal CA[1:0].

The command address clock signal CA_CLK is a clock signal for the command address line. The command address signal CA[1:0] may be synchronized to the rising edge and the falling edge of the command address clock signal CA_CLK. The command address clock signal CA_CLK may have a specific logical value (e.g., logic low) as a default value. The storage controller 1100 may generate the command address clock signal CA_CLK and may transmit the command address clock signal CA_CLK through the plurality of channels CH1 to CHm.

According to some example embodiments, at least some of the plurality of enable units EU1 to EUn are enabled through the command address chip enable signal. The at least some enable units thus enabled may disable the ODT, based on the ODT command or the ODT packet provided through the command address line. After the ODT is disabled, the at least some enable units may exchange the peak current information with each other through the command address line.

Alternatively, after disabling the ODT, the at least some enable units may receive the command address output signal through the command address line. The at least some enable units may enter the command address output mode based on the command address output signal. After entering the command address output mode, the at least some enable units may exchange the peak current information with each other through the command address line.

As some example embodiments, the disable of the ODT or the entry to the command address output mode may be set based on the first command address signal CA[0] and the second command address signal CA[1].

According to the above embodiments, non-volatile memories belonging to enable units or an enable unit enabled through the command address chip enable signal may share the peak current information with each other through the command address line implemented in a channel.

FIG. 6 is a timing diagram of a peak current information sharing operation of a storage device according to some example embodiments. For reference, an example in which two non-volatile memories are enabled to share the peak current information with each other is illustrated, but embodiments of the present disclosure are not limited thereto. Also, below, a time point “tx” (x being a natural number) is defined as indicating an arbitrary time point only in each drawing, it is reasonable that arbitrary time points are identical to each other or different from each other.

Referring to FIG. 6, a storage controller (e.g., refer to FIGS. 1 and 2) according to some example embodiments may support the inter-memory communication for a plurality of non-volatile memories through the command address line CA. The plurality of non-volatile memories may share the peak current information through the inter-memory communication.

At a time point t1, the storage controller transmits a select chip enable packet SCE through the command address line CA. The select chip enable packet SCE which is a packet for transmitting data is used when starting or resuming a data burst on the data line DQ. The storage controller may transmit the select chip enable packet SCE before the ODT is disabled, and then, the data transmission through the data signal DQ may be started or resumed.

At a time point t2, the storage controller transmits an ODT command ODT OFF for ODT disable through the command address line CA. The ODT command ODT OFF may be provided to a plurality of target non-volatile memories (e.g., an enable unit sharing the command address chip enable signal of FIG. 5) and/or all of a plurality of non-target non-volatile memories except for the plurality of target non-volatile memories. A plurality of non-volatile memories targeted for a request of the ODT command ODT OFF may at least disable the ODT before a time point t3. After the time point t3 at which the disable of the ODT is completed, a plurality of non-volatile memories at least sharing the same command address chip enable signal are capable of receiving a signal shared through the command address line CA.

Also, from the time point t2, the data burst may be provided through the data line DQ. For example, when the storage controller starts or resumes the program operation through the select chip enable packet SCE, the storage controller may transmit program data “DATA” through the data line DQ. An example in which data are transmitted through the data line DQ from the time point t2 to a seventh time point t7 is illustrated in FIG. 6, but this is provided only as an example.

As the data burst is provided, a peak current may be generated in the plurality of non-volatile memories. In particular, when there are performed operations requiring relatively large current consumption such as sequential program, there may be a need to monitor the peak current.

From a fourth time point t4, the plurality of non-volatile memories initiate the inter-memory communication through the command address line CA. A time interval for the inter-memory communication may be allocated to each of the plurality of non-volatile memories. For example, the time interval may have a preset magnitude or may include a given number of clock cycles (or periods). Each of the plurality of non-volatile memories may transmit a signal through the command address line CA in the time interval allocated thereto. That is, the time intervals allocated to the plurality of non-volatile memories do not overlap each other on a time domain.

The order in which the plurality of non-volatile memories transmit signals may be set in advance, may be set by the storage controller, or may be set by a non-volatile memory corresponding to a master from among the plurality of non-volatile memories.

As some example embodiments, one non-volatile memory may calculate (or predict) a peak current value and may transmit peak current information indicating the peak current value to the remaining non-volatile memories through the command address line CA in the allocated time intervals. For example, a time interval from t4 to t5 is allocated to a first non-volatile memory, and first peak current information PCI_NVM1 is provided to the command address line CA during the time interval from t4 to t5. A time interval from t5 to t6 is allocated to a second non-volatile memory, and second peak current information PCI_NVM2 is provided to the command address line CA during the time interval from t5 to t6. After the time point t6, the first non-volatile memory and the second non-volatile memory alternately transmit signals through the command address line CA. Each non-volatile memory shares own peak current information in the allocated time interval.

According to the above embodiments, the storage controller controls the inter-memory communication through the ODT disable, and the plurality of non-volatile memories are capable of sharing the peak current information through the command address line CA. In particular, while a storage device operates (e.g., performs the program or read operation) through the data line DQ, the command address line CA may be utilized to share the peak current information.

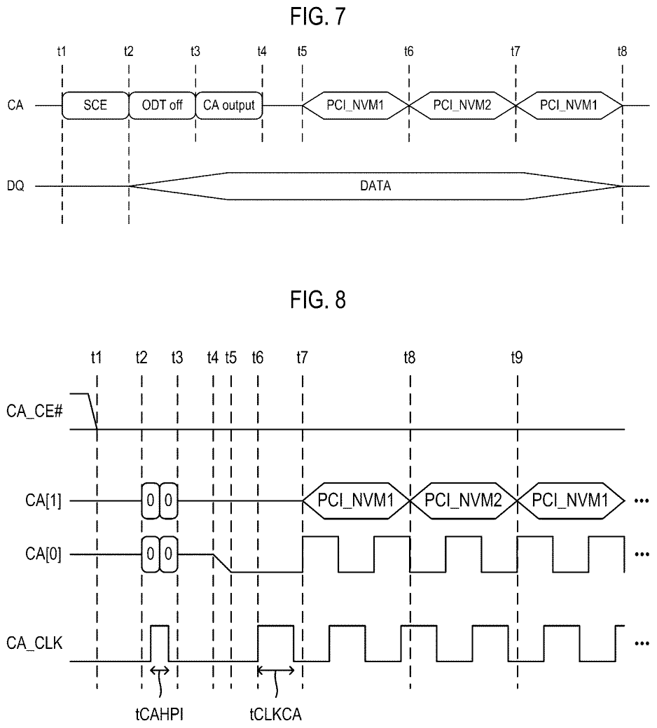

FIG. 7 is a timing diagram of a peak current information sharing operation after a storage device according to some example embodiments enters a command address output mode. Below, additional description associated with the signals and operations described with reference to FIG. 6 will be omitted to avoid redundancy.

Referring to FIG. 7, at a time point t1, the select chip enable packet SCE is provided through the command address line CA. At a time point t2, the data “DATA” are provided through the data line DQ in response to the select chip enable packet SCE. Also, at the time point t2, the ODT command ODT OFF for ODT disable is provided through the command address line CA. During a time interval from t2 to t3, the ODT of all of a plurality of non-volatile memories is disabled based on the ODT command ODT OFF.

At the time point t3, the storage controller transmits a command address output signal “CA output” for entering the command address output mode through the command address line CA. The plurality of non-volatile memories may receive the command address output signal “CA output” through the command address line CA and may enter the command address output mode based on the command address output signal “CA output”. For example, the plurality of non-volatile memories may operate in the command address output mode from a time point t4. Alternatively, the plurality of non-volatile memories may receive the command address output signal “CA output” until the time point t4 and may enter the command address output mode in a time interval from t4 to t5.

The plurality of non-volatile memories may initiate the inter-memory communication by disabling the ODT and entering the command address output mode during the time interval from t2 to t4. During a time interval from t5 to t8, the plurality of non-volatile memories may share the peak current information through the command address line CA. For example, during the time interval from t5 to t8, the first peak current information PCI_NVM1 and the second peak current information PCI_NVM2 are alternately provided through the command address line CA.

FIG. 8 is a detailed timing diagram of a peak current information sharing operation after a storage device according to some example embodiments enters a command address output mode.

Referring to FIG. 8, a storage device according to some example embodiments may enter the command address output mode after disabling the ODT of a plurality of non-volatile memories.

A command address chip enable signal CA_CE#maintains logic high before a time point t1. From the time point t1, the command address chip enable signal CA_CE#may transition to logic low. That is, the plurality of non-volatile memories (e.g., the enable unit described with reference to FIG. 5) receiving the corresponding command address chip enable signal CA_CE#are enabled (or selected) from the time point t1.

At a time point t2, a storage controller transmits the first command address signal CA[1] and the second command address signal CA[0] including a command address output header of “00” through a command address line. The command address output header is transmitted from the time point t2 to a third time point t3. Non-volatile memories enabled through the command address chip enable signal CA_CE#enter the command address output mode based on the command address output header.

Also, the command address clock signal CA_CLK toggles once during tCAHPI in the time interval from t2 to t3, and the command address output header is synchronized to the command address clock signal CA_CLK.

In a time interval from t4 to t5, the storage controller sets the first command address signal CA[1] and the second command address signal CA[0] corresponding to the command address line to high-impedance. From the time point t5, the command address output mode is initiated.

During a time interval from t5 to t7, the storage controller transmits the first command address signal CA[1] and the second command address signal CA[0] including a preamble through a command address line.

From the time point t6, the storage controller transmits the command address clock signal CA_CLK. For example, the command address clock signal CA_CLK toggles during tCLKCA while maintaining logic high (or logic low). For example, the storage controller may provide the command address clock signal CA_CLK until the command address output mode ends.

From the time point t7, the second command address signal CA[0] toggles in response to the command address clock signal CA_CLK. The second command address signal CA[0] acts as a strobe signal for the first command address signal CA[1] during the command address output mode. Also, as the second command address signal CA[0] toggles, the first command address signal CA[1] is provided from the time point t7.

According to some example embodiments, the enabled non-volatile memories may initiate the inter-memory communication after entering the command address output mode (i.e., after the time point t5). Through the command address line, the enabled non-volatile memories transmits the first command address signal CA[1] including the peak current information and the second command address signal CA[0] toggling based on an internal clock signal. In this case, each of the enabled non-volatile memories may transmit the first command address signal CA[1] including the peak current information during the enabled time interval.

For example, the first command address signal CA[1] including the peak current information PCI_NVM1 of the first non-volatile memory is provided during the time interval from t7 to t8, and the first command address signal CA[1] including the peak current information PCI_NVM2 of the second non-volatile memory is provided during the time interval from t8 to t9.

After the time point t9, the first and second non-volatile memories may repeat the operation of sharing the first command address signal CA[1] in synchronization with the second command address signal CA[0] until the command address output mode ends.

As some example embodiments, the first non-volatile memory may be defined as a master, and the second non-volatile memory may be defined as a slave. From the time point t7, the master and the slave may repeat the operation of sharing the first command address signal CA[1] including the peak current information in synchronization with the second command address signal CA[0] until the command address output mode ends. When a peak current whose value is greater than or equal to the threshold value is detected from the master, the slave may suspend or delay the scheduled operation.

Afterwards, the command address output mode may be ended. For example, like the case of entering the command address output mode, the storage controller may end the command address output mode by setting the first and second command address signals CA[1] and CA[0] to high-impedance and allowing the command address chip enable signal CA_CE#to transition to logic high.

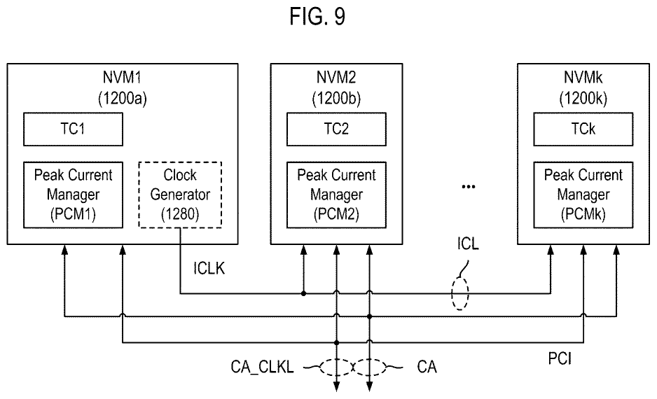

FIG. 9 illustrates a plurality of non-volatile memories according to some example embodiments.

Referring to FIG. 9, a plurality of non-volatile memories NVM1 to NVMk include the plurality of peak current managers PCM1 to PCMk and the plurality of on-die termination circuits TC1 to TCk. Through the plurality of peak current managers PCM1 to PCMk and the plurality of on-die termination circuits TC1 to TCk, the plurality of non-volatile memories NVM1 to NVMk may generate and share the peak current information PCI and may perform the ODT disable operation. In particular, after disabling the ODT (or entering the command address output mode), the plurality of non-volatile memories NVM1 to NVMk may share the peak current information PCI with each other through the command address line CA. Of cause, operations (e.g., program and read operations) using a data line may also be performed during the inter-memory communication.

The plurality of non-volatile memories NVM1 to NVMk may be connected through the command address clock line CA_CLKL and may receive the command address clock signal CA_CLK for the command address line CA from the outside (e.g., a storage controller) through the command address clock line CA_CLKL.

As some example embodiments, one non-volatile memory (or one or more non-volatile memories) among the plurality of non-volatile memories NVM1 to NVMk may include a clock generator 1280 configured to generate an internal clock signal ICLK for the plurality of non-volatile memories NVM1 to NVMk. The clock generator 1280 may generate the internal clock signal ICLK which the plurality of non-volatile memories NVM1 to NVMk use for the inter-memory communication according to the above embodiments. One non-volatile memory may transmit the internal clock signal ICLK to the remaining non-volatile memories among the plurality of non-volatile memories NVM1 to NVMk through an internal clock line ICL. In this case, the plurality of non-volatile memories NVM1 to NVMk may use the internal clock signal ICLK instead of the command address clock signal CA_CLK according to the above embodiments as a synchronization signal for the command address line CA.

When the internal clock signal ICLK is used as a synchronization signal, the command address clock signal CA_CLK may not toggle. That is, the command address clock signal CA_CLK may have a specific logical value (e.g., logic low) while the internal clock signal ICLK toggles. The command address line CA may provide the peak current information PCI depending on the toggle of the internal clock signal ICLK.

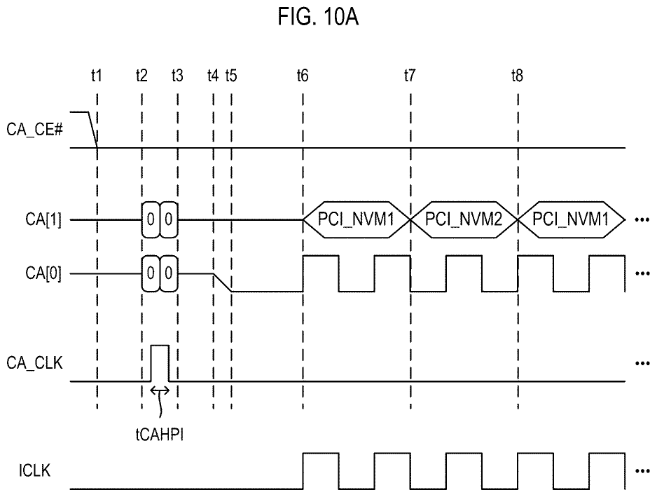

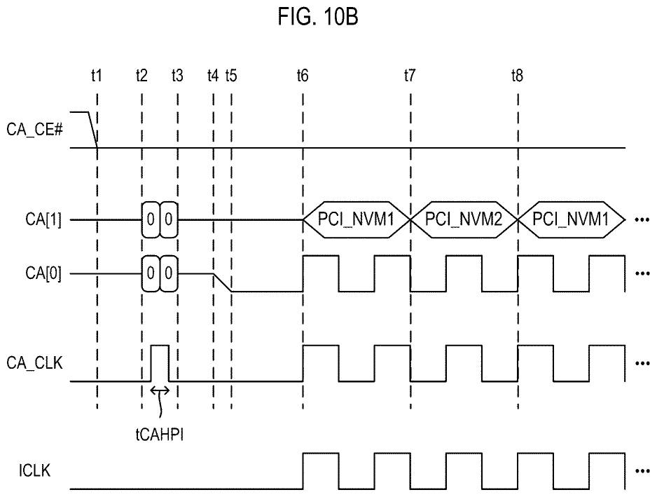

FIGS. 10A and 10B are detailed timing diagrams of a peak current information sharing operation based on an internal clock signal after a storage device according to some example embodiments enters a command address output mode.

First, referring to FIG. 10A, a storage device according to some example embodiments may enter the command address output mode and may then share the peak current information based on the internal clock signal ICLK.

The command address chip enable signal CA_CE#maintains logic high before a time point t1 and transitions to logic low from the time point t1.

At a time point t2, the first command address signal CA[1] and the second command address signal CA[0] included the command address output header of “00” are provided. Also, to provide the synchronization of the command address output header, the command address clock signal CA_CLK toggles once during tCAHPI in a time interval from t2 to t3.

In a time interval from t4 to t5, the first command address signal CA[1] and the second command address signal CA[0] may be set to the high-impedance state; in a time interval from t5 to t6, the first command address signal CA[1] and the second command address signal CA[0] including the preamble is provided through the command address line.

From the time point t6, the internal clock signal ICLK is provided through the internal clock line according to the above embodiments. As the internal clock signal ICLK toggles, the second command address signal CA[0] also toggles. The first command address signal CA[1] provides the peak current information in synchronization with the second command address signal CA[0]. While the peak current information is shared, the command address clock signal CA_CLK provided from a storage controller maintains logic low.

In a time interval from t6 to t8, the peak current information PCI_NVM1 and PCI_NVM2 associated with different non-volatile memories are provided through the first command address signal CA[1].

As some example embodiments, when the command address clock signal CA_CLK does not toggle due to the internal clock signal ICLK in the command address output mode, the command address output mode may be ended after a preset or predefined time passes. For example, the storage controller may end the command address output mode after the preset time passes from a time point at which the storage controller enters the command address output mode.

Next, referring to FIG. 10B, as some example embodiments, the command address clock signal CA_CLK may toggle based on the internal clock signal ICLK, and likewise, the second command address signal CA[0] of the command address line CA may also toggle based on the internal clock signal ICLK. The first command address signal CA[1] provides the peak current information in synchronization with the second command address signal CA[0]. In this case, the command address output mode may be ended based on the internal clock signal ICLK.

The plurality of non-volatile memories according to the above embodiments may enter the command address output mode and may then share the peak current information based on the internal clock signal ICLK without control of the storage controller.

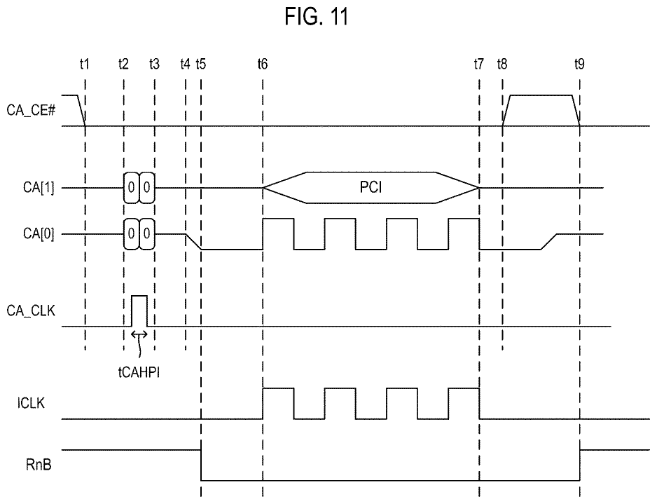

FIG. 11 is a detailed timing diagram of a peak current information sharing operation when a storage device according to some example embodiments enters a command address output mode and ends the command address output mode.

Referring to FIG. 11, at a time point t1, the command address chip enable signal CA_CE#transitions to logic low, and at a time point t2, the command address output header is provided through the first command address signal CA[1] and the second command address signal CA[0]. After a high-impedance interval from t4 to t5, a non-volatile memory enters the command address output mode. According to some example embodiments, a ready/busy signal RnB transitions to logic low at the time point t5.

When the non-volatile memory according to some example embodiments operates depending on the internal clock signal ICLK, during a time interval from t6 to t7, the second command address signal CA[0] is synchronized to the internal clock signal ICLK, and the first command address signal CA[1] provides the peak current information PCI.

To end the command address output mode, at an eighth time point t8, a storage controller makes the command address chip enable signal CA_CE#transition to logic high. According to some example embodiments, the storage controller may determine the time point t8, at which a specific time passes from the time point t5 at which the ready/busy signal RnB transitions to logic low, as an end time point of the command address output mode. Alternatively, the storage controller may determine the time interval from t5 to t9, in which the ready/busy signal RnB maintains logic low, as an operation interval of the command address output mode.

At a time point t9, the ready/busy signal RnB again transitions to logic high.

The command address clock signal CA_CLK toggles only once during tCAHPI. That is, according to some example embodiments, the entry and end of the command address output mode may be determined based on the ready/busy signal RnB.

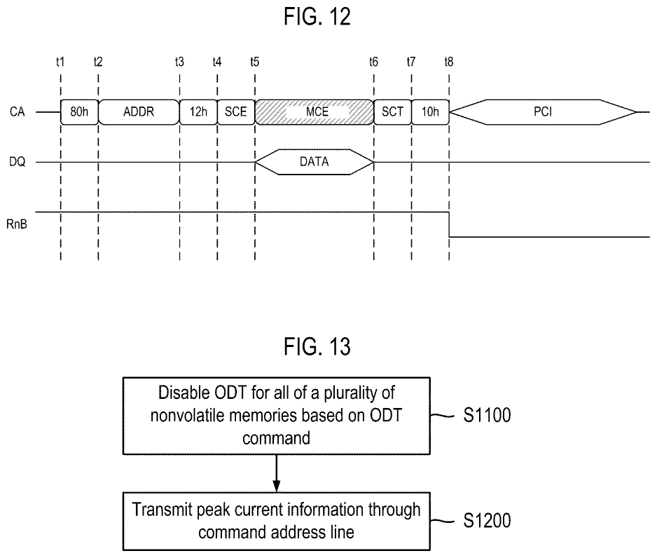

FIG. 12 is a timing diagram of a peak current information sharing operation and a program operation of a storage device according to some example embodiments.

Referring to FIG. 12, at a time point t1, a storage controller transmits a write command set 80h to 12h through the command address line CA. The write command set 80h to 12h indicates a data program operation. A column address and a row address may be provided through an address cycle ADDR starting at a time point t2.

After the command 12h starting at a time point t3 is ended, at a time point t4, the select chip enable packet SCE is provided through the command address line CA.

During a time interval from t5 to t6, the program data “DATA” are provided from the storage controller through the data line DQ. Also, during the time interval from t5 to t6, a command (or a packet) MCE for the inter-memory communication according to the above embodiments may be provided through the command address line CA. For example, during the time interval from t5 to t6, the ODT command for ODT disable and/or the command address output header for entering the command address output mode may be provided through the command address line CA.

At the time point t6, the storage controller transmits a select chip terminate packet SCT through the command address line CA. The second code 10h of the write command set is provided to the non-volatile memory at a time point t7, and the ready/busy signal RnB transitions to the low level at an eighth time point t8. At the same time, from the eighth time point t8, the peak current information PCI may be shared between a plurality of non-volatile memories through the command address line CA.

FIG. 13 is a flowchart of an operating method of a non-volatile memory according to some example embodiments.

Referring to FIG. 13, in operation S1100, a non-volatile memory may disable the ODT, based on the ODT command directing the non-volatile memory to disable the ODT for all of a plurality of non-volatile memories included in the non-volatile memory. As some example embodiments, the ODT disable for all of the plurality of non-volatile memories according to operation S1100 may be an initiation condition of the inter-memory communication.

As some example embodiments, the operating method may further include receiving a select chip enable packet through the command address line before operation S1100.

In operation S1200, the non-volatile memory may transmit the peak current information through the command address line separated from a data line. Operation S1200 may be repeatedly performed in time intervals allocated to the plurality of non-volatile memories. That is, different non-volatile memories may perform operation S1200 in different time intervals.

According to some example embodiments, operation S1200 may further include transmitting a first command address signal including peak current information through the command address line and transmitting a second command address signal toggling based on an internal clock signal.

As some example embodiments, the operating method may further include comparing a peak current value (or a value obtained by summing peak current values) indicated by the peak current information with the threshold value and stopping the scheduled operation when the peak current value is greater than or equal to the threshold value.

Through the operating method according to the above embodiments, the peak current information may be shared between non-volatile memories through the command address line.

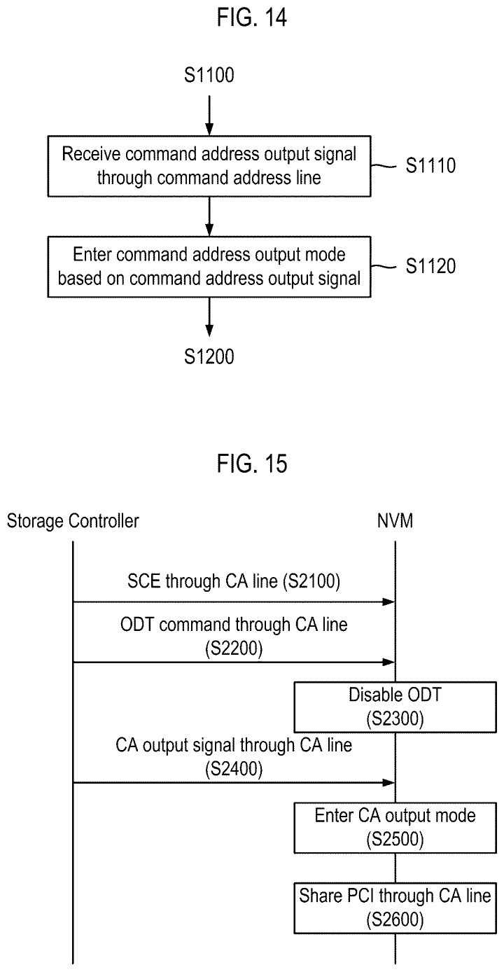

FIG. 14 is a flowchart of a command address output mode entering method according to some example embodiments.

Referring to FIG. 14, after the ODT is disabled according to operation S1100 (refer to FIG. 13), in operation S1110, the non-volatile memory may receive the command address output signal through the command address line. For example, the command address output signal may include the command address output header.

In operation S1120, the non-volatile memory may enter the command address output mode based on the command address output signal. After operation S1120, the non-volatile memory may share the peak current information through operation S1200 (refer to FIG. 13). That is, the transmission of the peak current information may be performed after operation S1120 in which the non-volatile memory enters the command address output mode.

FIG. 15 is a flowchart of an operating method of a storage device according to some example embodiments.

Referring to FIG. 15, in operation S2100, a storage controller transmits the select chip enable packet to a non-volatile memory through the command address line.

In operation S2200, the storage controller transmits the ODT command to the non-volatile memory through the command address line. The ODT command may indicate the disable of the ODT. Accordingly, in operation S2300, the non-volatile memory disables the ODT based on the ODT command.

In operation S2400, the storage controller transmits the command address output signal to the nonvolatile memory through the command address line. In operation S2500, the non-volatile memory enters the command address output mode based on the command address output signal. In operation S2600, the non-volatile memory may share the peak current information PCI with the remaining non-volatile memories through the command address line.

In the above embodiments (refer to FIGS. 1 to 15), the peak current information PCI or PCI_NVM may include status information or pieces of telemetry information, which the non-volatile memory is capable of outputting, in addition to the current information.

According to the present disclosure, a non-volatile memory sharing peak current information by using a separate command address protocol, a storage device including the same, and a method thereof may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a plurality of non-volatile memories; and
a storage controller connected to the plurality of non-volatile memories through a data line and a command address line separated from the data line,
wherein the plurality of non-volatile memories are respectively configured to:
transmit peak current information through the command address line after on die termination (ODT) for all of the plurality of non-volatile memories is disabled.

2. The storage device of claim 1, wherein one non-volatile memory among the plurality of non-volatile memories is configured to transmit the peak current information to remaining non-volatile memories among the plurality of non-volatile memories through the command address line, in a time interval allocated to the one non-volatile memory.

3. The storage device of claim 1, wherein the storage controller is configured to transmit a command address output signal through the command address line, and
wherein the plurality of non-volatile memories are configured to enter a command address output mode based on the command address output signal, after the ODT is disabled.

4. The storage device of claim 3, wherein the plurality of non-volatile memories are respectively configured to transmit the peak current information after entering the command address output mode.

5. The storage device of claim 1, wherein the storage controller is configured to transmit an ODT command indicating the disable of the ODT for all of the plurality of non-volatile memories through the command address line, and
wherein the plurality of non-volatile memories are configured to disable the ODT based on the ODT command.

6. The storage device of claim 1, wherein one non-volatile memory among the plurality of non-volatile memories is configured to:
generate an internal clock signal for the plurality of non-volatile memories;
and transmit the internal clock signal to remaining non-volatile memories among the plurality of non-volatile memories through an internal clock line.

7. The storage device of claim 6, wherein the plurality of non-volatile memories are configured to transmit a first command address signal including the peak current information and a second command address signal toggling based on the internal clock signal through the command address line.

8. The storage device of claim 6, wherein the storage controller is configured to transmit a command address clock signal for the command address line to the plurality of non-volatile memories through a command address clock line, and
wherein the command address clock signal has a specific logical value while the internal clock signal is toggling.

9. The storage device of claim 1, wherein the storage controller is configured to transmit a select chip enable packet through the command address line before the ODT is disabled.

10. The storage device of claim 1, wherein the command address line transmits a first command address signal and a second command address signal, which are synchronized to a rising edge and a falling edge of a command address clock signal for the command address line, and
wherein the disable of the ODT or an entry to a command address output mode is set based on the first command address signal and the second command address signal.

11. A method of operating a non-volatile memory, the method comprising:
disabling on die termination (ODT) for all of a plurality of non-volatile memories included in the non-volatile memory, based on an ODT command indicating a disable of the ODT; and
transmitting peak current information through a command address line separated from a data line.

12. The method of claim 11, wherein the transmitting of the peak current information is repeatedly performed in time intervals allocated to the plurality of non-volatile memories.

13. The method of claim 11, further comprising:
receiving a command address output signal through the command address line after the ODT is disable; and
entering a command address output mode based on the command address output signal.

14. The method of claim 13, wherein the transmitting of the peak current information is performed after entering the command address output mode.

15. The method of claim 11, further comprising:
generating an internal clock signal for the plurality of non-volatile memories; and
transmitting the internal clock signal through an internal clock line.

16. The method of claim 15, wherein the transmitting of the peak current information includes:
transmitting a first command address signal including the peak current information through the command address line; and
transmitting a second command address signal toggling based on the internal clock signal.

17. The method of claim 11, further comprising:
receiving a select chip enable packet through the command address line before the ODT is disabled.

18. The method of claim 11, further comprising:
stopping a scheduled operation when a peak current value indicated by the peak current information is greater than or equal to a threshold value.

19. A non-volatile memory comprising:
a memory cell array;
an input/output circuit connected to a data line transmitting write data or read data associated with the memory cell array and a command address line separated from the data line, and configured to enable or disable on die termination (ODT); and
a control logic circuit,
wherein the control logic circuit is configured to disable the ODT based on controlling the input/output circuit and then transmit peak current information through the command address line.

20. The non-volatile memory of claim 19, further comprising:
a clock generator configured to generate an internal clock signal for the command address line.
